(19) United States
(12) Patent Application Publication
(10) Pub. No.: US 2008/0211668 A1
(43) Pub. Date: Sep. 4, 2008

(54) METHOD AND SYSTEM TO DETECT HUMANS OR ANIMALS WITHIN CONFINED SPACES WITH A LOW RATE OF FALSE ALARMS

(76) Inventors: Walter V. Dixon, Delanson, NY (US); Andrew M. Leach, Clifton Park, NY (US); Mark Kornfein, Latham, NY (US)

Correspondence Address: General Electric Company;Global Patent Operation, 187 Danbury Road, Suite 204, Wilton, CT, 06897-4122, US

(21) Appl. No.: 11/681,498

(22) Filed: Mar. 2, 2007

(51) Int. Cl. G08B 13/00

(52) U.S. Cl. 340/541

(57) ABSTRACT

The present disclosure describes a detection system and methods for detecting a presence of a person or animal within a confined space with a low false alarm rate. The detection system may include a chemical detector to determine whether respiratory gas concentrations within the confined space exceed a predetermined concentration threshold. The detection system may further include an accelerometer-controlled, range-controlled radar unit to detect movement within the confined space during times in which acceleration of the confined space is less than a predetermined acceleration threshold. In this manner, a measured respiratory gas concentration that initially indicates a presence of a person or animal within the confined space may be confirmed by motion detection.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of contract No. N66001-05-C-6015 awarded by the Department of Homeland Security.

### BACKGROUND

1. Field of the Invention

The subject matter of the present disclosure relates to security detection systems generally, and more particularly, to embodiments of a low cost system and method that may be used to detect, with a low rate of false alarms, the presence of humans and/or animals within confined spaces.

2. Discussion of Related Art

The detection of human beings and/or animals within confined spaces is an area of growing interest. For example, immigration and border-control agencies are tasked with determining, with a high degree of confidence, whether particular types of confined spaces contain human and/or animal stowaways. One particular non-limiting example of such a type of confined space is a general purpose, general freight container (hereinafter “container”). Non-limiting examples of a general purpose, general freight container include a sea-land container, an over-the-road semi-trailer, and the like.

Detection systems employed in bygone periods have typically produced high rates of false alarms and experienced other problems. Two categories of detection systems historically used to detect human or animal presence come to mind: motion detection systems and chemical detection systems. Each type of detection system is now discussed in turn.

Motion detection systems that utilize conventional motion and proximity sensors, such as (but not limited to) microwave impulse radar (“MIR”) (a.k.a., range-controlled radar (“RCR”), impulse radio, passive infrared (heat sensing), ultrasound, acoustic, and microwave Doppler devices are known, but are adversely affected by vibration, acceleration, temperature, weather, and other environmental conditions. For example, airborne particles, humidity, and heat can cause passive infrared sensors to generate false alarms. Additionally, the detection range of such sensors is limited and their signals can be absorbed and/or attenuated by objects within the area being monitored.

Ultrasound and microwave Doppler devices may be less affected by environmental conditions than passive infrared devices, but consume relatively large amounts of power. Additionally, microwave Doppler devices tend to false alarm due to signal interference when co-located. Additionally, such devices tend to be costly to construct and deploy, have limited penetration into various materials, and can trigger on distant objects as easily as near objects if not properly range gated.

Commercially available MIR or impulse radio devices can overcome many of the disadvantages associated with passive infrared, ultrasound, and microwave Doppler devices mentioned above, but suffer from clutter and electromagnetic attenuation by different media

Many of the different types of sensors mentioned above employ replaceable batteries as power sources. Such batteries typically last about thirty days. This is disadvantageous since the average transit time for freight containers delivered via ship (and/or other means) is about four to six weeks. It is also disadvantageous from a service perspective because drained batteries must be manually replaced, and this replacement process is costly and time-consuming. Another disadvantage is that replaceable batteries may be stolen.

Given these disadvantages, it is not surprising that line-of-sight detection (for those types of motion detection devices that require it) is particularly problematic when implemented in containers filled with materials possessing different densities. Acoustic detection of humans or animals through the monitoring of heartbeats or breathing fares no better when implemented in containers, and suffers high false alarm rates caused by external noise sources, non-limiting examples of which include engine noise, road noise, and the like. Thermal detection, though potentially very sensitive, is also problematic when implemented in containers that experience a wide range of ever-changing ambient and internal temperatures. Range gated radar detection, though potentially able to “see around” objects in containers, suffers from a key potential interference, which is the false sensing of movement/acceleration as human or animal motion. Such movement/acceleration may be caused by transport of the container (e.g., via marine vessel, crane, truck, train, etc.), by shock to the outside of the container (e.g., rain falling on the container, objects (such as waves, hammers, strong winds, etc. striking the container, etc.), and/or by cargo that shifts within the container.

Chemical detection systems that utilize gas sensors to detect gases produced through respiration or other physiological functions have potentially good sensitivity and selectivity, but are adversely affected by a number of environmental factors, not the least of which is that a human and/or animal must detectably alter the air volume of the confined space (about 60,000 L+ for a container). Additionally, gases (or chemicals) present at very low concentrations require very long detection times or some form of pre-concentration. Pre-concentrating each gas sample is disadvantageous because it uses more power and quickly drains batteries.

Chemical detection systems may also be adversely affected by the biological activity of plants and microorganisms, and/or external sources of gases (e.g., manual or machine stuffing of containers, exhaust from combustion engines, etc.), which can artificially elevate gas levels within the container and thereby generate false alarms. Because an estimated 6% to 8% of container cargoes are bioactive, measuring container gas concentrations alone produces false alarm rates that exceed 1%.

The false alarm rate (e.g., percentage of false alarms) is important. In the transportation sector, where a container ship may carry upwards of 3,000 containers. A 1% or 2% false alarm rate means that about 30 to 60 of these containers would be subject to additional inspection(s). For economic and logistics reasons, a false alarm rate of less than about 1% is needed.

Thus, a new detection system and method are needed that can accurately detect the presence of a human and/or animal within a confined space during a period of several hours (or less) with a low false alarm rate.

### BRIEF DESCRIPTION

The multi-stage detection system and methods for detecting the presence of a person or animal within a confined space described herein were invented to mitigate at least the potential sources of chemical and/or motion detector noise noted above.

For example, in an embodiment of the invention, a chemical detector activates a motion sensor after a respiratory gas concentration within a confined space exceeds a predetermined concentration threshold that indicates a high probability of a human or animal being present within the confined space. The motion sensor may include an accelerometer that is coupled with a range-controlled radar unit. The accelerometer determines when the range-controlled radar unit can be most effectively activated (e.g., during periods where the acceleration of the container is less than a predetermined acceleration threshold. In one exemplary embodiment, the predetermined acceleration threshold may include at least one of a predetermined frequency and amplitude. Appropriately gated to allow detection of motion within the confined space that has a high probability of being caused by a human or animal, the range-controlled radar unit operates (when activated by the accelerometer) to detect motion within the confined space that confirms the chemical detector's indication that a human or animal is present within the confined space. Embodiments of the system and method described herein mitigate the interferences described above and significantly reduce the false alarm rate.

As used herein, the phrase “confined space” may include a space: that is large enough for a person (infant, child, youth, adult) or animal to enter and occupy; is not designed for continuous occupancy by the person or animal; has a limited or restricted means of entry or exit, and is configured to move or be transported from one location to another. Non-limiting examples of confined spaces include: cargo holds, interior spaces of transporters, and the like. As used herein, the term “transporter” may include, but is not limited to, automobiles, marine vessels, aircraft, spacecraft, recreational vehicles, military vehicles, mining and construction vehicles, railway rolling stock, trucks, general purpose, general freight containers (e.g., “containers”), trailers, and the like. An interior space of an automobile may include, but is not limited to, a trunk. As mentioned above, examples of a container include, but are not limited to, a sea-land container, an over-the-road semi-trailer, and the like.

In an embodiment, a method may include a step of determining that a respiratory gas concentration within the confined space exceeds a predetermined concentration threshold. The predetermined concentration threshold may be chosen to indicate that a presence of the human or animal within a confined space has been detected. The method may further include a step of detecting motion within the confined space during a time in which an acceleration of the confined space is determined to be less than a predetermined acceleration threshold. The motion detected by the range-controlled radar unit may confirm the results of the prior step (e.g., that the presence of a human or animal within the confined space has been detected).

In another embodiment, a detection system to detect a presence of a human or animal within a confined space may comprise a motion detector, a system controller, and a chemical detector. The chemical detector may be configured to output to the system controller data representative of a measured respiratory gas concentration within the confined space that exceeds a predetermined concentration threshold. The predetermined concentration threshold may indicate the presence of a human or animal within the confined space.

In another embodiment, a detection system may comprise a chemical detector, an accelerometer, and a range-controlled radar unit. The chemical detector may be configured to measure a respiratory gas concentration within a confined space. The chemical detector may be further configured to output a signal indicating an initial detection of one of human and animal presence within the confined space when the measured respiratory gas concentration exceeds a predetermined threshold. The accelerometer may be configured to activate in response to the signal outputted by the chemical detector. The accelerometer may be further configured to measure an acceleration of the confined space when activated by the chemical detector. The accelerometer may also be configured to output a signal when the measured acceleration of the confined space is less than a predetermined acceleration threshold. The range-controlled radar unit may be configured to activate in response to the signal outputted by the accelerometer. The range-controlled radar unit may be further configured to measure motion within the confined space when activated by the accelerometer. The range-controlled radar unit may be further configured to output a signal that confirms the initial detection of the one of human and animal presence within the confined space.

Other features and advantages of the claimed subject matter will become apparent by examining the following detailed description in connection with the accompanying drawings.

### BRIEF DESCRIPTION OF THE DRAWINGS

In the accompanying drawings,

FIG. 1 is a diagram illustrating interaction of components of an embodiment of a detection system and a flowchart of a method of operating the detection system;

FIG. 2 is a block diagram illustrating components of an embodiment of a chemical detector that forms part of the detection system of FIG. 1;

FIG. 3 is a block diagram illustrating components of an embodiment of a motion detector that forms part of the detection system of FIG. 1;

FIG. 4 is a block diagram illustrating components of an embodiment of a system controller that forms part of the detection system of FIG. 1;

FIG. 5 is a graph illustrating simulated data representing an impact of a single human within a confined space having about 60,000 L air volume;

FIG. 6 is a graph illustrating measured and simulated data representing detection of a single human within a sealed cargo container; and

FIG. 7 is a flowchart of a method of detecting a presence of a human or an animal within a confined space.

Like reference characters designate identical or corresponding components and units throughout the several views.

### DETAILED DESCRIPTION

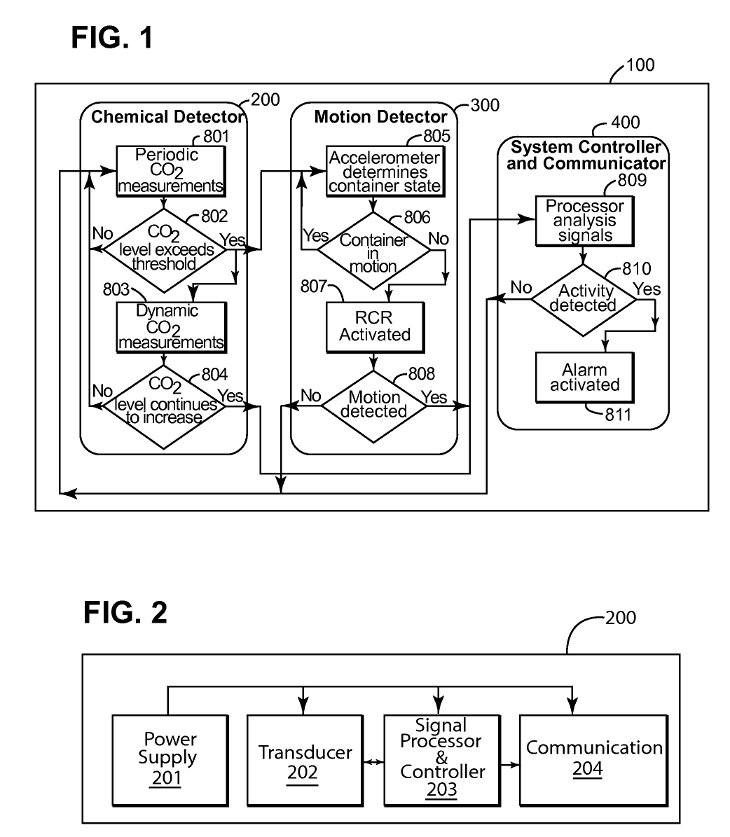

FIG. 1 is a diagram illustrating interaction of components 200, 300, 400 of an embodiment of a detection system 100 and a flowchart of a method of operating the detection system. The method may include one or more of steps 801, 802, 803, 804, 805, 806, 807, 808, 809, 810, and 811, each of which will be further described below.

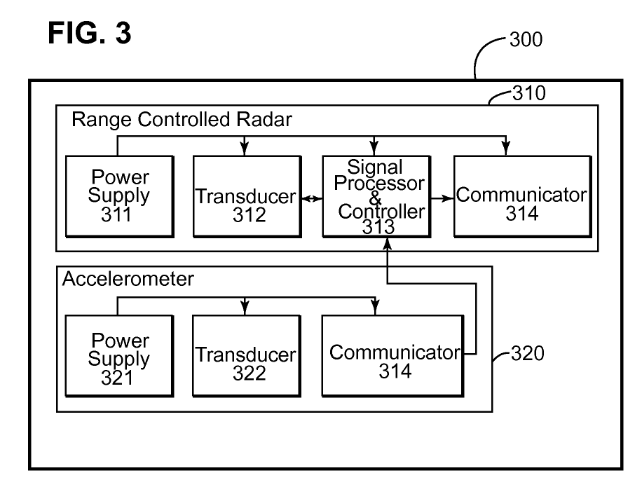

Referring now to FIG. 1, the detection system 100 may include a chemical detector 200 configured to detect respiratory gases, a motion detector 300 configured to detect a predetermined amount of motion, and a system controller/communicator 400 configured to manage the operation of and process/analyze the data outputted from the chemical detector 200 and the motion detector 300. When the chemical detector 200 detects a predetermined level of respiratory gas within the confined space, the chemical detector 200 may send an activation signal to the motion detector 300 directly and/or via the system controller/communicator 400. Although not shown in FIG. 1, the motion detector 300 may include sub-elements such as a single-axis or multi-axis accelerometer coupled with a range-controlled radar unit. The range-controlled radar unit is appropriately range gated to detect human or animal motion within a confined space. The accelerometer and range-controlled radar unit comprising the motion detector 300 are shown in FIG. 3 and further described below.

In an embodiment, each of the components 200, 300, and 400 of the detection system 100 may be co-located with the others and/or in wired communication therewith. Alternatively, each of the components 200, 300, and 400 may be dispersed from the others and/or in wireless communication therewith. All or part of the components 200, 300, 400 of the detection system 100 may be fixedly or detachably mounted to an interior surface of a confined space (using an adhesive other fastening means). To protect the components 200, 300, and 400 of the detection system 100 from damage, they may be positioned within the confined space in an area that does not interfere with cargo loading/unloading. Additionally, the components 200, 300, 400 of the detection system 100 may be mounted within the confined space at a location or locations where they will not be damaged by moving or shifting cargo. Illustratively, the components 200, 300, 400 may be installed in a recessed interior portion of the confined space and/or protected with a crush-resistant or crush-proof device. In one or more of the embodiments herein described, the components of the detection system 100 may be inter-operatively linked (via wireless or wired communication channels) with each other.

It is contemplated that the embodiments described herein may be modified to include more or fewer chemical, motion, and/or other types of detectors, and/or that the embodiments described herein may be modified to alter the detector locations illustratively described herein. Such modifications may be necessary, depending on the type, size, and/or contents of the confined space being monitored, the types of respiratory gases being measured, the kinds of system components used, etc.

Exemplary, non-limiting locations of the various components of the detection system 100 within a confined space are now described. In one embodiment, the range-controlled radar unit that comprises part of the motion detector 300 may be mounted at an end of a confined space near the top (e.g., ceiling) of the confined space. In other embodiments, the range-controlled radar unit may be mounted at any suitable location within the confined space, including, but not limited to, a central portion of the confined space's ceiling.

Additionally, one or more accelerometers may be mounted to one or more interior walls of the confined space at any suitable height(s).

In an embodiment, one or more chemical detectors may be mounted within the confined space proximate a bottom (e.g., floor) of the confined space. Mounting the one or more chemical detectors proximate the bottom of the confined space may be advantageous in detecting concentrations of respiratory gas(es) (such as CO₂) that are heavier than air. In another embodiment, one or more chemical detectors may be dispersed at various heights and locations within the interior of the confined space, depending on whether the type(s) of respiratory gas being measured is/are heavier or lighter than air. One or more chemical detectors may also be mounted on the exterior of the confined space and configured to measure ambient concentrations of one or more types of respiratory gases.

In another exemplary embodiment, a range-controlled radar unit is mounted within a confined space proximate a top of the confined space, a first chemical detector is mounted within the confined space proximate a bottom of the confined space, and a second chemical detector is mounted externally to the confined space. Optionally, the second chemical detector may be located proximate an air vent (if any) of the confined space. In such an embodiment, the first chemical detector is configured to detect concentrations of a predetermined type of respiratory gas within the confined space, and the second chemical detector is configured to detect concentrations of the predetermined type of gas outside the confined space.

The data obtained by the first chemical sensor and the second chemical sensor may be fused and computer-analyzed (using one or more algorithms known to a skilled artisan) to determine a probability that a human or an animal is present within the confined space. For example, a situation where the first (internal) chemical detector registers a low concentration of CO₂ and the second (external) chemical detector registers a high concentration of CO₂ may indicate a high probability that the confined space is being affected by an external source of CO₂. An example of such an external source is a traffic tunnel that surrounds the exterior of the confined space.

Data indicative of concentrations of respiratory gases within the confined space that exceed a predetermined concentration threshold and data indicative of detected movement within the confined space may be wirelessly transmitted by the system controller/communicator 100 outside of the confined space. This transmitted data may be received by a handheld computer (not shown) brought within a predetermined distance of the exterior of the confined space and/or may be received by a computer (not shown) remote from the confined space. Thus, in an embodiment where the confined space is a cargo container, a customs agent, border-patrol agent, security guard (or other type of personnel) may retrieve real-time (or near-real time) data about respiratory gas levels and/or movement within the cargo container simply by bringing an appropriately configured handheld computer near the cargo container. The exact distance will vary depending on a number of factors such as where the communication antenna(s) of the system controller/communicator are located, type of handheld computer used, strength/type of communication signal outputted by the system controller/communicator 400, etc.

Additionally, or alternatively, this data about respiratory gas levels and/or movement within the cargo container may be relayed to a remote computer via satellite and/or sensors strategically placed at points through which the cargo container must pass (e.g., at a road gate of a port facility, at a quay crane, at a container stack area, at a railcar loading area, and the like) Thus, one advantage is that the customs or border control agent does not have to individually query each container.

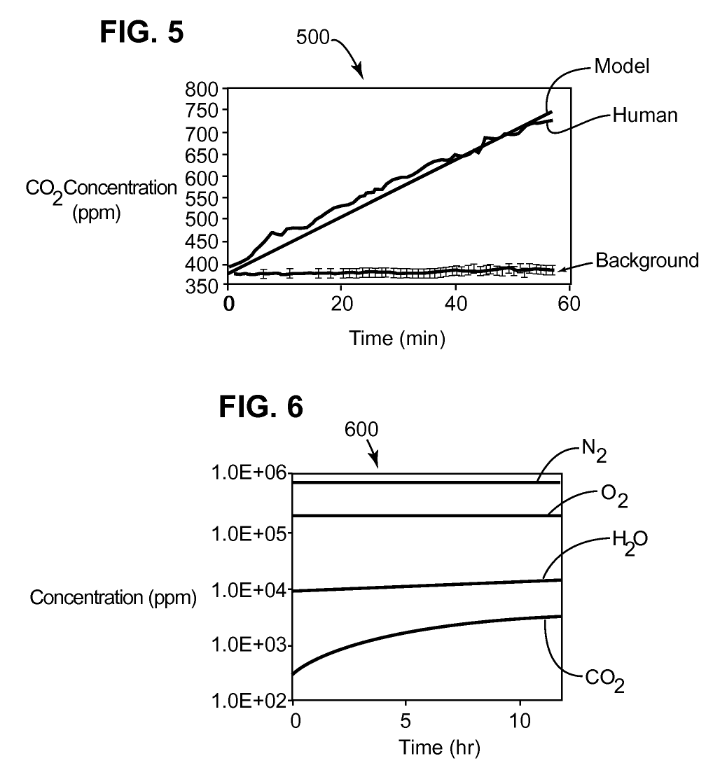

In use, the detection system 100 may operate as indicated by the method steps shown in FIG. 1. The detection process may begin (at step 801) with the chemical detector 200 making periodic measurement of respiratory gases within the confined space. The measured respiratory gas may be at least one of CO₂, nitrogen, oxygen, water vapor, hydrogen sulfide, ammonia, a volatile organic compound (“VOC”) and/or combinations thereof. From FIGS. 5 and 6 it appears that CO₂ exhibits the most significant change in relative concentration between inhaled and exhaled air. Accordingly, in one embodiment, the chemical detector 200 may be configured to measure only CO₂ concentrations within a confined space. In an alternate embodiment, the chemical detector 200 may measure CO₂ concentrations as well as concentrations of other respiratory gases. In yet another embodiment, the chemical detector 200 may measure concentrations of respiratory gases other than CO₂.

The periodic measurements performed at step 801 may be one sample about every several minutes, but longer and shorter sampling rates are possible and envisioned, depending on, among other factors, the air volume of the confined space being monitored. Illustratively, an acceptable sampling rate for a container may be one measurement about every ten (10) minutes.

At step 802, data indicative of a measured level (concentration) of respiratory gas within the confined space is analyzed to determine whether the measured concentration of respiratory gas exceeds a predetermined concentration threshold indicative of a presence of a human or animal within the confined space.

Once a concentration greater than the threshold value has been detected, the motion detector's accelerometer may be activated (step 805) to determine (at step 806) whether the confined space is experiencing acceleration that exceeds a predetermined acceleration threshold or is steady (e.g., the acceleration measured by the accelerometer is below the predetermined acceleration threshold, which indicates that the container is either stationary or traveling at a substantially constant rate of speed). Additionally, the chemical detector's duty cycle may be increased (step 803) to more frequently monitor respiratory gas levels. In FIG. 1, the increased duty cycle of the chemical detector 200 is indicated by the phrase “Dynamic CO₂ Measurements.” Illustratively, an acceptable increased sampling rate may be one measurement per minute. Other increased sampling rates, however, are possible and envisioned. In this manner, innocuous increases in CO₂ or other respiratory gas levels due to external sources can be detected and disregarded.

If the CO₂ or other respiratory gas levels continue to increase (step 804) in a defined pattern, data indicative of these increased levels may be transmitted to the controller/communicator 400 for analysis (step 809). Otherwise, the method may loop back to the step 801 of taking periodic respiratory gas measurements, as described above.

Referring again to the steps 805 and 806, if the accelerometer detects an acceleration that exceeds the predetermined acceleration threshold, it may wait until the next chemical detection event (e.g., about 1 minute). If the concentration of respiratory gases continues to increase, the accelerometer may again determine whether the confined space is experiencing acceleration that exceeds a predetermined acceleration threshold or is steady. This process may continue for about 30 cycles, at which time the chemical detector 200 may register a probable detection event. Thereafter, when the accelerometer determines that the confined space is sufficiently stable to minimize (or eliminate) false motion detection alarms, the range control radar may be activated (at step 807) to detect motion (if any) within the confined space that has a high probability of being caused by a human or an animal within the confined space.

Incidentally, a continued respiratory gas elevation over a period of time may signal a greater probability of potential alarm, while a decrease in respiratory gas concentration over time may suggest that an external source contributed to the previous level.

At step 808, if no motion is detected, the method may loop back to the step 801 of periodically monitoring the respiratory gas levels, as described above. Alternatively, if motion is detected, data indicative of the same is sent to the system controller/communicator 400 for analysis and/or fusion with the data indicative of above-threshold concentrations of respiratory gas and/or increasing concentrations of respiratory gas. At step 809, the system controller/communicator 400 processes the data outputted from each of the chemical detector 200 and the motion detector 300 to confirm (at step 810) the likelihood of whether human or animal activity within the confined space has been detected. If the probability of human or animal motion is less than a predetermined probability threshold, the method again loops back to the step 801. Alternatively, if the probability of human or animal detection equals or exceeds the predetermined probability threshold, the method may proceed to the step 811 of activating an alarm, which indicates to the appropriate personnel that a person or animal has been detected within a particular monitored confined space.

Illustrative operational principles and architecture of the chemical detector 200, the motion detector 300, and the system controller/communicator 400 are now described with reference to FIGS. 2, 3, and 4. FIG. 2 is a block diagram illustrating exemplary components 201, 202, 203, and 204 of a chemical detector 200. A power supply 201 (e.g., one or more batteries, one or more fuel cells, and the like) provides electrical energy to each of the transducer 202, the signal processor/controller 203, and the communicator 204. In an embodiment, non-replaceable batteries are used, which provide sufficient power to operate the chemical detector 200 about 3-5 years (or longer).

The optical transducer 202 may include a dual channel optical path, with one channel providing respiratory gas concentration information and the second channel providing reference signals related to the sensor's inherent performance. In an embodiment, the chemical detector's low duty cycle operation and dual optical channel configuration may eliminate the need for recalibration of the chemical detector 200 in the field.

A semi-permeable membrane may be incorporated into the packaging of the chemical detector 200 to protect the transducer 202 from dirt or other particulate matter. The semi-permeable membrane may comprise silicon, which exhibits a high permeability to CO₂ while limiting the transport of many other abundant gases. Additionally, the semi-permeable membrane may limit the exposure of the transducer 202 to potentially corrosive environments including sea air.

The signal processor/controller 203 may be configurable to allow the chemical detector 200 to be optimized for confined spaces of varying dimensions. Signal processing within the chemical detector 200 may be limited to relatively simple operations including analog-to-digital conversions and the comparison of individual signal levels and signal level sequences with stored values and patterns. While the chemical detector is performing periodic measurements of container respiratory gas concentrations, the signal processor/controller 203 may perform a simple comparator function with a preset concentration threshold value. Once this concentration threshold has been exceeded, in addition to triggering activation of the motion detector 300, the chemical detector 200 may more frequently measure the respiratory gas concentrations within the confined space. While operating in this higher duty cycle, the signal processor/controller 203 may store individual sensor readings (e.g., data outputted by the chemical detector that is representative of respiratory gas concentrations within the confined space) to generate a pattern related to temporal fluctuation in respiratory gas concentrations. This pattern may be compared with stored patterns to determine if the source of the increased respiratory gas(es) is one or more humans or animals within the confined space, or is a source external to the confined space. In addition to reducing the rate of false alarms, this dynamic measurement procedure may provide an estimate of the number of humans or animals located within the confined space based on the rate at which the respiratory gas concentrations increase. An example of a suitable processor is the MSP430 series ultra-low power central processing unit manufactured by Texas Instruments.

The communicator 204 is a device that converts the detection data into signals that can be transmitted (via cable or wirelessly) to at least the system controller/communicator 400. Communications functions of the chemical detector 200 may involve at least three actions. First, the chemical detector 200 may signal the motion detector 300 in the event of a potential alarm. Second, the chemical detector may directly transmit data indicative of respiratory gas concentration to the system controller/communicator 400 for determination of an alarm event. Finally, the chemical detector 200 may periodically communicate with the system controller/communicator to provide the chemical detector's operational status. These communication actions may occur through wired or wireless circuits.

The chemical detector 200 may be selected from among the following exemplary types of devices: an optical unit based on non-dispersive infrared absorption spectroscopy (“NDIR”), an electrical unit based on the resistance at metal oxide semiconductor (“MOS”) junctions, and a resonance detector based on analyte absorption on polymer coated quartz crystal microbalances (“QCMs”). Illustratively, if measuring only CO₂ levels, a NDIR-type chemical detector 200 may be used. It is contemplated that other types of chemical detectors known to a skilled artisan may also be used.

Referring now to FIG. 3, a block diagram illustrating component 310 (and its subcomponents 311, 312, 313, and 314) and component 320 (and its subcomponents 312, 322, and 323) of a motion detector 300. As shown, the motion detector 300 may comprise a range-controlled radar unit 310 coupled with and activated by a single-axis or multi-axis accelerometer 320. Either or both of the range-controlled radar unit 310 and the accelerometer 320 may be coupled with the system controller/communicator 400.

The range-controlled radar unit 310 may include a power supply (e.g., one or more batteries, one or more fuel cells, and the like) provides electrical energy to each of the transducer 312, the signal processor/controller 313, and the communicator 314. In an embodiment, non-replaceable batteries are used, which provide sufficient power to operate the range-controlled radar unit 310 about 3-5 years (or longer).

The transducer 312 is a device that converts detection of reflected radar pulses into electrical energy (e.g., data indicative of detected motion). The signal processor/controller 313 may be a MSP430 series ultra low power central processing unit (manufactured by Texas Instruments) that provides analog-to-digital conversion, signal comparison, and control functions. The signal processor/controller 313 may be configurable to allow the range-controlled radar to be optimized for confined spaces of varying dimensions. The communicator 314 is a device that converts the motion detection data into signals that can be transmitted (via cable or wirelessly) to at least the system controller/communicator 400.

Although the sub-components are not shown, the range-controlled radar unit 310 may further comprise at least a transmitter with a pulse generator, a receiver with a pulse detector, timing circuitry, a signal processor, a transmitting antenna, and a receiving antenna. These enumerated components are not further explained in detail, as their architecture and operation will be apparent to a skilled artisan. To assist readers of this disclosure who may be less skilled, a general description of how a range-controlled radar unit operates is provided.

In operation, the transmitter of the range-controlled radar unit emits rapid, wideband radar pulses, each of which is about several nanoseconds long. In seeking the return signals (e.g., a complex series of echoes reflected from targets within the “radar bubble,” a space around and/or extending from the directional or multi-directional transmitter), the range-controlled radar unit samples only those echoes that occur in a narrow time window after each pulse transmission. This time window is often referred to as a “range gate.” The time delay after each pulse transmission corresponds to a distance traveled by each pair of outbound and inbound (reflected) radar pulses. Consequently, range gates can be predetermined to detect only targets that are within a fixed distance from the transmitter. In practice, many radar pulses are rapidly transmitted and all returns are averaged, which has the effect of reducing clutter (e.g., background noise).

The length of range gate used by embodiments of the claimed invention will vary depending on such factors as: the type of confined space being monitored, the type, quantity, and location of any cargo (or other items) that may exist within the confined space, the brand, type, and/or mounting location of the range-controlled radar unit employed, and the like. When optimally mounted within a confined space and optimally range gated to account for at least the factors noted above, a range-controlled radar unit will detect human or animal motion within the confined space, even if cargo (or other object) is between the human or animal and the range-controlled radar unit.

When an accelerometer, optimally mounted within the confined space and configured to determine whether the confined space (and/or its cargo) is accelerating, is coupled with the range-controlled radar unit, the range-controlled radar unit can be instructed to operate only during times in which the confined space and/or its cargo is/are steady (e.g., not accelerating or de-accelerating). In this manner acceleration of the confined space due to external sources can be accounted for and/or eliminated, which makes detecting human or animal motion within the confined space easier, and reduces the rate of false alarms.

Referring again to FIG. 3, the accelerometer 320 may include a power supply 321 that provides electrical energy to a transducer 322 and a communicator 323. An example of a suitable type of accelerometer 320 is a single-axis ADXL 103 series accelerometer manufactured by Advanced Devices, which operates on about 3 volts and outputs an analog voltage proportional to the acceleration. Alternatively, a multi-axis accelerometer may be used. The accelerometer 320 may be mounted within a confined space with at least one axis aligned substantially orthogonal to a plane of the wall on which it is attached. In an embodiment, the accelerometer 320 may be controlled and read by the signal processor/controller 313.

Additionally, the motion detector 300 (and/or the chemical detector 200) may include a tamper detection device that will signal when the motion detector 300 (and/or the chemical detector 200) have been improperly accessed.

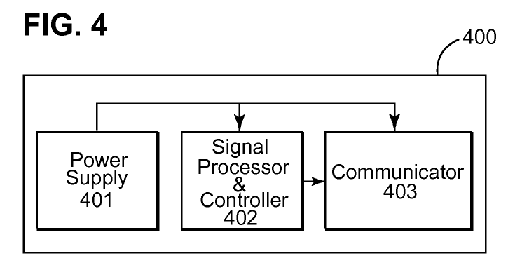

Referring now to FIG. 4, a block diagram illustrating components of a system controller/communicator 400 is shown. A power supply 401 delivers electrical energy to each of the signal processor/controller 402 and the communicator 403. The power supply 401 (e.g., one or more batteries, one or more fuel cells, and the like) provides electrical energy to each of the processor/controller 402 and the communicator 403. In an embodiment, non-replaceable batteries are used, which provide sufficient power to operate the system controller/communicator 400 about 3-5 years (or longer).

The system controller/communicator 400 may perform at least the following functions: power distribution, signal processing and sensor control, and (optionally) communication with a main signal processor located internal or external to the confined space. The signal processor/controller 402 may be configured to accept inputs from the chemical detector 200 and the motion detector 300, and to analyze such inputs to determine (with a low false alarm rate) the presence or absence of a human or animal within a confined space. Simple operations include analog to digital conversion, logic operations, and comparison with stored profiles. An example of a suitable type of processor is the MSP430 series ultra low power central processing unit described above.

The communicator 403 may wirelessly communicate with other components of a container or confined-space security system via radio frequency (“RF”) signaling. Accordingly, the communicator 403 may comprise a 2.4 GHz frequency hopping radio that uses a second-generation Chipcon radio integrated circuit. An exemplary radio protocol is 802.15.4, with a Zigbee-like MAC and networking layer. In other embodiments, other types of radios and radio protocols known to a skilled artisan may be used.

FIG. 5 is a graph 500 illustrating simulated data representing an impact of a single human within a confined space having about 60,000 L air volume. A non-limiting example of a confined space having about this air volume is a 40′ general purpose, general freight container. This graph, which plots CO₂ Concentration (ppm) vs. Time (min), demonstrates that a single human can be detected within a confined space by periodically measuring respiratory gas concentrations therein. The background CO₂ concentration, as indicated by the graph 500, was about 390+10 ppm. As shown by the graph 500, the presence of the human within the confined space results in a CO₂ concentration of greater than about 700 ppm within one hour, with the concentration rising at about a rate of greater than 5 ppm per minute. To determine the probability of whether this measured data indicates the presence of a human within a confined space, the measured data can be fit to previously generated models that include measured air exchange rate values for the confined space.

FIG. 6 is a graph 600 illustrating simulated data representing detection of a single human within the confined space of about 60,000 L air volume. Graph 600 plots CO₂ Concentration (ppm) vs. Time (hours). From graph 600 it can be seen that of the measured levels of carbon dioxide (CO₂), nitrogen (N₂), oxygen (O₂), water vapor (H₂O), CO₂ may exhibit the largest increase over time.

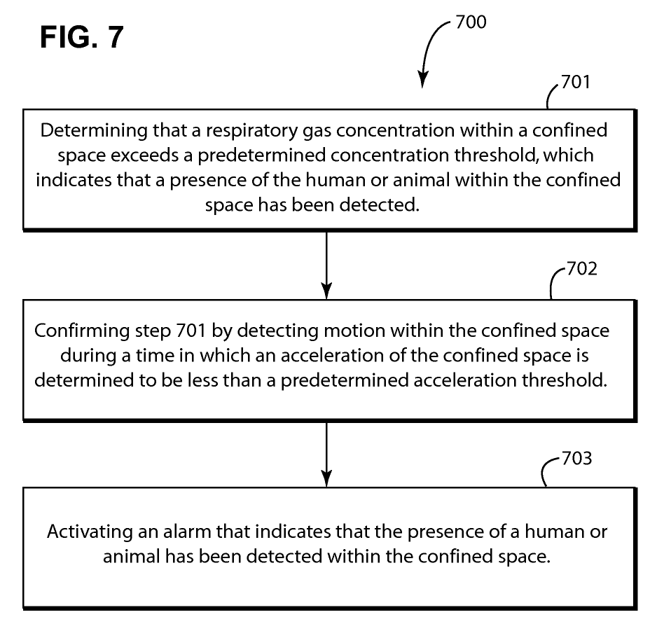

FIG. 7 is a flowchart 700 of another method of detecting a presence of a human or animal within a confined space. The method 700 may begin (at step 701) with determining that a respiratory gas concentration within the confined space exceeds a predetermined concentration threshold, which indicates that the presence of the human or animal within the confined space has been detected. The method 700 may proceed to step 702 of detecting motion within the confined space during a time in which an acceleration of the confined space is determined to be less than a predetermined acceleration threshold. In an embodiment, the detected motion resulting from step 702 confirms (the initial indication of step 701) that the presence of a human or animal within the confined space has been detected. At step 703, an alarm is activated that indicates that the presence of a human or animal has been detected within the confined space.

In an alternative embodiment, the steps of the method 700 may be modified and/or reversed. For example, the range-controlled radar (linked to an accelerometer) may be configured as the primary detection device, and the chemical detector may be configured as a secondary detection device. In such an embodiment, the accelerometer may activate the range-controlled radar when motion/acceleration in the confined space is below a predetermined threshold. If, after being activated, the range-controlled radar detects motion within the confined space, it may activate the chemical detector to look for a rise in concentrations of CO₂ or other respiratory gas (or gases). If the chemical detector determines that the respiratory gas concentrations are rising and/or have exceeded a predetermined concentration threshold, an alarm may be activated to indicate that a presence of a human or an animal has been detected within the confined space.

The overall false positive rate of an embodiment of the detection system 100 may be about 1% or less.

The components and arrangements of the detection system and method for detecting the presence of a human or animal in a confined space, shown and described herein are illustrative only. Although only a few embodiments of the invention have been described in detail, those skilled in the art who review this disclosure will readily appreciate that substitutions, modifications, changes and omissions may be made in the design, operating conditions and arrangement of the preferred and other exemplary embodiments without departing from the spirit of the embodiments as expressed in the appended claims. Accordingly, the scope of the appended claims are intended to include all such substitutions, modifications, changes, and omissions.

What is claimed is:

1. A method for detecting a presence of a human or animal within a confined space, the method comprising:
determining that a respiratory gas concentration within the confined space exceeds a predetermined concentration threshold, which indicates that the presence of the human or animal within the confined space has been detected; and
detecting motion within the confined space during a time in which an acceleration of the confined space is determined to be less than a predetermined acceleration threshold, wherein the detected motion confirms that the presence of a human or animal within the confined space has been detected.

2. The method of claim 1, further comprising:
activating an alarm indicating the presence of the human or animal has been detected within the confined space.

3. The method of claim 1, wherein the respiratory gas is at least one of nitrogen, oxygen, carbon dioxide, water vapor, hydrogen sulfide, ammonia, a volatile organic compound and combinations thereof.

4. The method of claim 1, wherein the confined space is a freight container.

5. A detection system to detect a presence of a human or animal within a confined space, the detection system comprising:
a motion detector;
a system controller coupled with the motion detector; and
a chemical detector configured to output to the system controller data representative of a measured respiratory gas concentration within the confined space that exceeds a predetermined concentration threshold, which indicates the presence of a human or animal within the confined space,
wherein the chemical detector is further configured to output an activation signal to the motion detector when the measured respiratory gas concentration within the confined space exceeds the predetermined concentration threshold.

6. The detection system of claim 5, wherein the confined space is a freight container.

7. The detection system of claim 5, wherein the motion detector is configured to output to the system controller data indicative of motion detected within the confined space during a time in which an acceleration of the confined space is less than a predetermined acceleration threshold.

8. The detection system of claim 7, wherein the system controller is configured to activate an alarm after receiving the data outputted from the chemical detector and the data outputted from the motion detector.

9. The detection system of claim 5, wherein the motion detector comprises:
an accelerometer configured to determine that an acceleration of the confined space is less than a predetermined acceleration threshold; and
a range-controlled radar unit coupled with the accelerometer.

10. The detection system of claim 9, wherein the range-controlled radar unit is gated for a predetermined distance.

11. The detection system of claim 9, wherein the range-controlled radar unit is configured to detect motion within the confined space only during a time when a signal received from the accelerometer indicates the acceleration of the confined space is less than the predetermined acceleration threshold.

12. The detection system of claim 9, wherein the range-controlled radar unit is mounted within the confined space proximate a top of the confined space.

13. The detection system of claim 12, wherein the chemical detector is mounted within the confined space proximate a bottom of the confined space.

14. The detection system of claim 5, wherein the respiratory gas is at least one of a gas selected from the group consisting of nitrogen, oxygen, carbon dioxide, water vapor, and a volatile organic compound.

15. The detection system of claim 5, wherein the system controller is further configured to determine whether the respiratory gas concentrations are increasing at a predetermined rate indicative of the presence of the human or animal.

16. The detection system of claim 5, wherein the system controller is further configured to store the data outputted from the chemical detector to generate a pattern related to temporal fluctuation in respiratory gas concentrations.

17. The detection system of claim 16, wherein the system controller is further configured to compare the pattern related to temporal fluctuation in respiratory gas concentrations with stored patterns to determine if a source of the increased respiratory gas or gases is one or more humans or animals within the confined space, or a source external to the confined space.

18. The detection system of claim 17, wherein the system controller is further configured provide an estimate of the number of humans or animals located within the confined space based on a rate at which the respiratory gas concentrations within the confined space increase.

19. The detection system of claim 5, wherein the detection system has a false alarm rate of about 1% or less.

20. The detection system of claim 5, further comprising a second chemical detector configured to measure ambient respiratory gas concentrations.

21. The detection system of claim 20, wherein the second chemical detector is mounted to an outside portion of the confined space.

22. The detection system of claim 9, wherein the range-controlled radar unit is configured to detect one of human and animal motion within the confined space, and is further configured to activate the chemical detector after detecting the one of human and animal motion.

23. A detection system, comprising:
a chemical detector configured to measure a respiratory gas concentration within a confined space and to output a signal indicating an initial detection of one of human and animal presence within the confined space when the measured respiratory gas concentration exceeds a predetermined threshold;
an accelerometer configured to activate in response to the signal outputted by the chemical detector, wherein the accelerometer is further configured to measure an acceleration of the confined space when activated by the chemical detector, and to output a signal when the measured acceleration of the confined space is less than a predetermined acceleration threshold; and
a range-controlled radar unit configured to activate in response to the signal outputted by the accelerometer, wherein the range-controlled radar unit is further configured to measure motion within the confined space when activated by the accelerometer, and to output a signal that confirms the initial detection of the one of human and animal presence within the confined space.

24. The detection system of claim 23, further comprising:
a system controller configured to receive at least the signals outputted by the chemical detector and the range-controlled radar unit, and to activate an alarm upon receipt of the signal outputted by the range-controlled radar unit.
